(19) United States
(12) Patent Application Publication
(10) Pub. No.: US 2008/0195421 A1
(43) Pub. Date: Aug. 14, 2008

(54) Electronic medical records exchange system

(75) Inventors: Michael Ludwig, Germantown, MD (US); Jeffrey H. Baybick, Crownsville, MD (US)

Correspondence Address: BLANK ROME LLP, 600 NEW HAMPSHIRE AVENUE, N.W., WASHINGTON, DC, 20037, US

(73) Assignee: Sunrise Medical Management, LLC

(21) Appl. No.: 11/705,500

(22) Filed: Feb. 13, 2007

(51) Int. Cl. G06Q 10/00; G06Q 50/00

(52) U.S. Cl. 705/3

(57) ABSTRACT

A medical records system is disclosed having an interface module having a user interface to allow a user to request and retrieve data regarding patient records, data regulating software and a database of medical records and patient data. The interface module is configured to allow for selection of patient identifiers, selection of data requests with respect to the patient identifiers and the medical records and retrieval of information related to the patient identifiers and the medical records, where the patient identifiers, data requests and retrieval of information are communicated between the interface module and the database through regulation by the data regulating software.

### BACKGROUND OF THE INVENTION

1. Field of the Invention

The present invention relates to the handling and search of medical records. More particularly, the present invention is directed to a system that allows information stored in electronic medical records to be freely exchanged between medical database and software systems.

2. Background of the Related Art

Healthcare providers create patient information during the course of their business at healthcare facilities, such as hospitals, clinics, laboratories and medical offices. Electronic data processing can be used by healthcare providers to automate the creation, use and maintenance of patient records.

Some prior art systems include U.S. Pat. No. 4,315,309, a patient report generating system for receiving, storing and reporting medical test data for a patient population and U.S. Pat. No. 3,872,448, a system for automatically handling and processing hospital data, such as patient information and pathological test information using a central processing apparatus. In U.S. Pat. No. 5,924,074, a system that captures patient data, such as patient complaints, lab orders, medications, diagnoses, and procedures, at its source at the time of entry using a graphical user interface having touch screens is disclosed. However, these electronic data processing systems cannot handle patient data in the wide variety of data formats typically produced by healthcare providers, such as physicians, laboratories, clinics and hospitals.

One problem that the medical community confronts with respect to information technology is the incompatibility of data originating from various existing proprietary databases. The medical community is in need of a system that allows the universal transmission of patient data to any provider privileged to receive such communication. Many problems confront the medical world in modernizing data transfer, including that there is currently no universal information technology program that can be adopted by everyone and the need is too great to wait for such a system to be adopted. In addition, the cost involved in adopting such a universal system would be prohibitive.

Not only would the adoption of such a system be costly in terms of expenditures, there would be great resistance by the various medical practitioners who have already spent great sums of money for equipment, software and training in adopting such a system. As such, there is, therefore, a need for systems that bridge the gaps formed by the differing systems so that data can be freely exchanged and utilized.

### SUMMARY OF THE INVENTION

Accordingly, it is an object of the invention to allow for the management of medical records, to streamline ordering processes and reduce error. To that end, one embodiment of the present invention is directed to a medical records system having an interface module having a user interface to allow a user to request and retrieve data regarding patient records, data regulating software and a database of medical records and patient data. The interface module is configured to allow for selection of patient identifiers, selection of data requests with respect to the patient identifiers and the medical records and retrieval of information related to the patient identifiers and the medical records, where the patient identifiers, data requests and retrieval of information are communicated between the interface module and the database through regulation by the data regulating software.

In addition, the interface module may be a personal computer connected to a network and the database may be a networked database, where the interface module may be a tablet personal computer wirelessly connected to the network. The interface module may be a personal computer and the user interface may be a browser window being served from a network source connected with the database and the data regulating software. The user interface may be configured to allow for the entry of new patient data and the data regulating software may be configured to convey the new patient data to the database in a format used by the database. The user interface may be configured to allow for selection of patient identifiers through the search for an ID, at least a partial name and an appointment date.

The data regulating software may be configured to translate the data obtained from the database such that the data are formatted to meet the requirements of the interface module. The database and the data regulating software may be accessed over a network by the interface module, with the data regulating software configured to mediate communication between the database and the interface module. The database of medical records and patient data may include multiple databases of medical records and patient data, so that the data regulating software provides data translation into separate formats for each of the multiple databases. The data regulating software may also be compatible with multiple commercial practice management software packages.

According to another embodiment of the present invention, a method of managing patient data includes the steps of authenticating a user based on an entered user identifier and offering a choice of test requests or report retrieval. When test requests are chosen, the method includes requesting selection of patient identifier or entry of new patient information, offering selection of tests that can be requested for an identified patient and producing and sending a request for selected tests. When report retrieval is chosen, the method includes preparing reports of testing in progress or testing that has been completed, based on criteria entered by the user and displaying the prepared reports to the user.

According to another embodiment of the present invention, a method of accessing medical data includes the steps of providing a user with an user interface and awaiting the user to request data regarding patient records, including selection of patient identifiers, selection of data requests with respect to the patient identifiers and the medical records and retrieval of information related to the patient identifiers and the medical records. The method thereafter includes communicating the patient identifiers, data requests and retrieval of information to data regulating software, translating the patient identifiers, data requests and retrieval of information by the data regulating software and forwarding the translated patient identifiers, data requests and retrieval of information to a database of medical records and patient data. The translating step translates patient identifiers, data requests and retrieval of information into a format used by the database. The method may also be performed by a computer program on a computer readable medium according to another embodiment.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1 illustrates a schematic of a medical records system, in accordance with a preferred embodiment of the invention;

FIG. 2 illustrates the layering involved in the present invention, with the software, data regulating, and database layers, according to preferred embodiments of the present invention;

FIG. 3 illustrates a screen capture of the module selection portion of the system, in accordance with a preferred embodiment of the invention;

FIG. 4 illustrates a screen capture of an ordering module toolbar of the system, in accordance with a preferred embodiment of the invention;

FIG. 5 illustrates a screen capture of a report module toolbar of the system, in accordance with a preferred embodiment of the invention;

FIG. 6 illustrates a screen capture of the order setup screen of the system, in accordance with a preferred embodiment of the invention;

FIG. 7 illustrates screen captures of searches that can be performed using the system, with FIGS. 7(a) to 7(d) providing exemplary searches, in accordance with a preferred embodiment of the invention;

FIG. 8 illustrates a screen capture of search results determined by the system, in accordance with a preferred embodiment of the invention;

FIG. 9 illustrates a screen capture of an order creation in the system, in accordance with a preferred embodiment of the invention;

FIG. 10 illustrates a screen capture of a specimen itemization screen of the system, in accordance with a preferred embodiment of the invention;

FIG. 11 illustrates a screen capture of a specimen clinical information section screen of the system, in accordance with a preferred embodiment of the invention;

FIG. 12 illustrates a screen capture of a specimen list selection screen of the system, in accordance with a preferred embodiment of the invention;

FIG. 13 illustrates a screen capture of a print specimen label screen of the system, in accordance with a preferred embodiment of the invention;

FIG. 14 illustrates a screen capture of an order panel screen of the system, in accordance with a preferred embodiment of the invention;

FIG. 15 illustrates a screen capture of the order verification screen of the system, in accordance with a preferred embodiment of the invention;

FIG. 16 illustrates a screen capture of the order logs selection screen of the system, in accordance with a preferred embodiment of the invention;

FIG. 17 illustrates a screen capture of a report lookup box of the system, in accordance with a preferred embodiment of the invention;

FIG. 18 illustrates a screen capture of a report list box results of the system, in accordance with a preferred embodiment of the invention;

FIG. 19 illustrates a screen capture of a data list selection screen of the system, in accordance with a preferred embodiment of the invention;

FIG. 20 illustrates a screen capture of an exemplary service list result of the system, in accordance with a preferred embodiment of the invention;

FIG. 21 illustrates a screen capture of a service type administration screen of the system, in accordance with a preferred embodiment of the invention;

FIG. 22 illustrates a screen capture of the panel line item management screen of the system, in accordance with a preferred embodiment of the invention;

FIG. 23 illustrates a screen capture of a data source administration screen of the system, in accordance with a preferred embodiment of the invention;

FIG. 24 illustrates a screen capture of a data source configuration screen of the system, in accordance with a preferred embodiment of the invention;

FIG. 25 illustrates a screen capture of the source address information screen of the system, in accordance with a preferred embodiment of the invention;

FIG. 26 illustrates a screen capture of a point of contact information screen of the system, in accordance with a preferred embodiment of the invention;

FIG. 27 illustrates a screen capture of a data source names screen of the system, in accordance with a preferred embodiment of the invention;

FIG. 28 illustrates a screen capture of a services offered screen of the system, in accordance with a preferred embodiment of the invention;

FIG. 29 illustrates a screen capture of a user list screen of the system, in accordance with a preferred embodiment of the invention;

FIG. 30 illustrates a flow chart for one process of using the medical records system, in accordance with a preferred embodiment of the invention; and

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

The present invention is directed to a system that allows for the rapid storage and retrieval of medical information. The system, according to at least one embodiment, includes a series of active server pages that allows a transparent exchange of medical record information. The present invention allows for existing (embedded but intrinsically incompatible) systems to interoperate by inserting a layer of data regulating software, available over the Internet. Without requiring changes or updates to the existing systems, the methodology of the present invention allows for the exchange of medical data between practices, hospitals and laboratories. Practitioners can continue to use their existing systems and no external data conversion processes are required.

As a practical demonstration of the exchange of medical records between divergent systems, a system in which pathology laboratory tests are ordered and results are retrieved on line is presented. Patient information from the practice management system used by the ordering physician is pushed to the system on demand. The incoming data is then translated and formatted to meet the requirements of the target software. In this case, the target data system is a commercially available software package specifically used by pathology laboratories. The loop is completed when the system retrieves the finished laboratory reports and makes them available to the ordering physician over the Internet. The present invention has compatibility with various commercial practice management packages including GCare, Emedsys, Medicrus, A4 Healthsystems, Misys, and WindoPath.

The data translation is completely invisible to users and in no way limits medical professionals from using the software packages of their choice. The present invention requires only standard and easily configurable access to the data sources being tapped. This allows for interoperability between disparate systems and requires the data translation layer to make determinations about the type of data and database that is being accessed.

The demonstration system detailed here accomplishes these goals at minimal cost. There is no investment in new or additional equipment and training time is minimal. Regardless of the system from which patient information is retrieved users are presented with a single graphical user interface. There is no upfront software cost, as the user of such a system merely needs to pay a nominal cost for each record transmission. The system is administrated from a central processing area so that the community of users does not bear this additional cost.

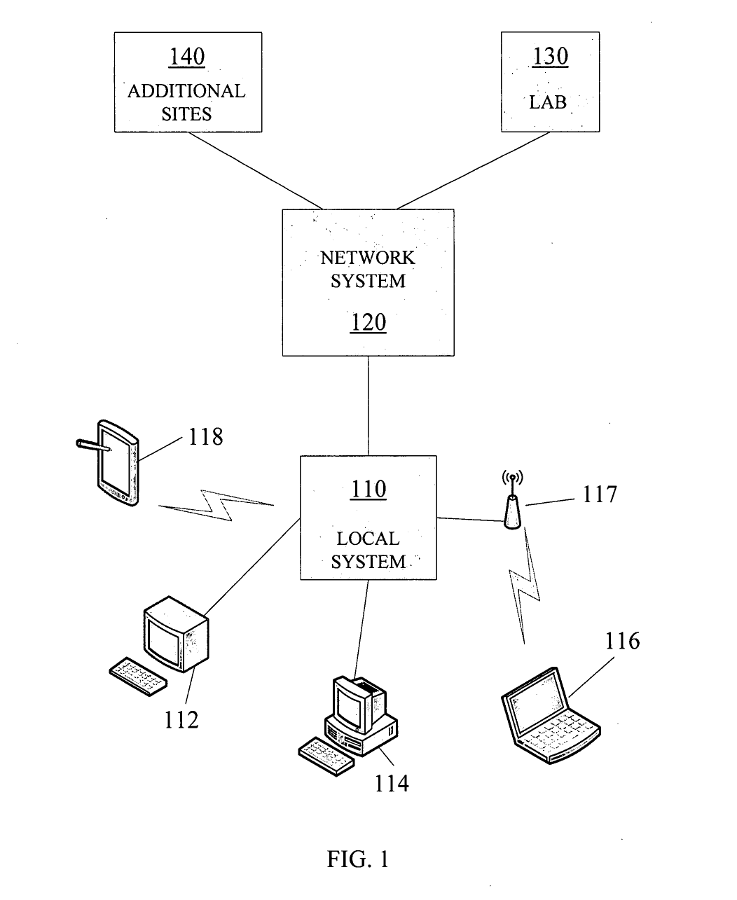

An exemplary system for the present invention is provided in FIG. 1. The local system 110 has various means to allow users to enter and retrieve data. These include dedicated terminals 112, connected personal computers 114, laptops 116 connected through wireless networking 117 and tablet PCs 118, connected wirelessly or through a connection. The local system 110, which in some embodiments may simply be a router, switch, or network interface, allows for connection to the larger system 120 that is connected to additional sites 140 and/or the laboratory 130, where testing may be carried out. It should be understood that the laboratory need not be a separate facility and the additional sites may be merely different departments at a single facility.

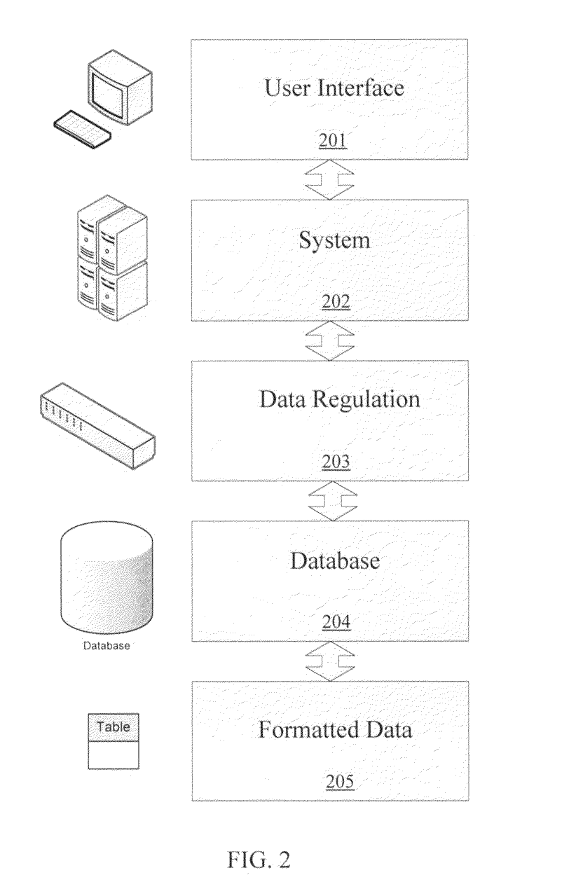

The present invention is also illustrated in FIG. 2, where the layers of interface, translation and databases are illustrated. The schematic illustrates the layering of the present invention, with layer 201 acting as a user interface that the clinician interacts with to lookup data, place orders for laboratory tests, etc. As discussed above, the user interface may be run on terminals, personal computers or other devices that allow for input and output of data. The user interface layer interacts with a system layer 202, which at minimum must be able to interact with a larger network. The network, as discussed above, can be within a given facility or be some distance away, connected though a network such as the Internet. Instead of accessing another server directly to obtain data to populate fields, the communication is mediated through the data regulation layer 203, where data conversion occurs. The data regulation layer acts as an intermediary for the database layer 204, where entries in the database have a particular format 205, that may not be directly compatible with the ordering system. Thus, for example, patient information, obtained from the formatted data 205, used by the ordering physician is converted, on demand, by the data regulation layer 203 and pushed to the ordering system. When a request is made by the ordering physician, the data regulation layer 203 provides the request in a format that the receiving system can understand.

There are many commercial database systems available to store patient demographic, including health insurance, information and medical histories. The system of the present invention may be used in conjunction with most commercial database systems. Database platforms that can be used with the present invention include SQL Server, Oracle, Sybase and Informix. The system can be used to exchange information with any ODBC compliant system and is compliant with HIPAA.

The purpose of the Ordering Module is to streamline the data entry process required for the online ordering of laboratory tests. The database interface results in a reduction of errors during specimen accessioning and allows an auditable data accounting trail to be recorded for each order. The Report Retrieval module is used to find, display, download, and print the laboratory results of the ordered tests. The final report may then be appended to the patient's electronic medical record.

As discussed above, a practical demonstration of the exchange of medical records between divergent systems is illustrated in the system described below, in which pathology laboratory tests are ordered and results are retrieved on line is presented. It should be noted that this system is merely exemplary of the present invention, and the present system encompasses all types of data management systems where data from disparate and possibly incompatible databases is accessed.

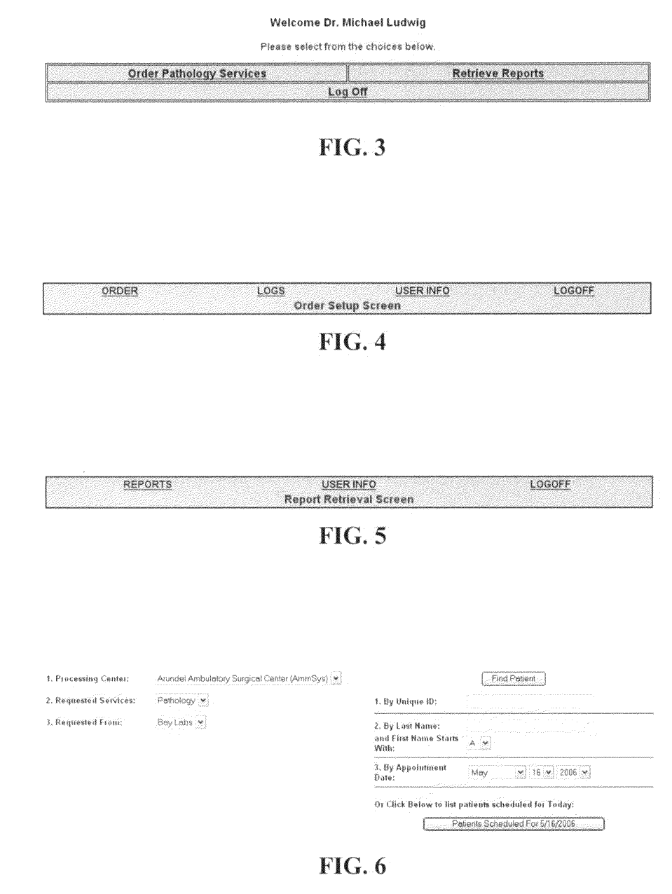

The system use begins with a login process. If a user has forgotten their username and/or password, an email address can be entered. If the system can match the address to a valid user, log in information will be sent via email. Thereafter, the user is presented with a module selection screen, as that illustrated in FIG. 3. The modules available to the user are displayed. The module may be selected by clicking on its name. In FIG. 3, the user may choose between “Order Pathology Services” (Ordering Module) or “Retrieve Reports” (Report Retrieval Module).

Toolbar buttons provide quick navigation within the modules. The toolbars for the Ordering and Reporting Modules are shown in FIGS. 4 and 5. The name of the current screen is shown on the second line of the toolbar. The functions of the Ordering toolbar are provided in TABLE 1, according to one embodiment of the present invention:

TABLE 1

| Order Toolbar Button | Function |
|---|---|
| ORDER | Start Ordering Module |
| LOGS | Show Ordering Logs and Reports |
| USER INFO | Enter User Contact Information |
| | Change Username/Password |
| | Control Report Distribution List |
| LOGOFF | Log Off User |

The functions of the Reporting Modules toolbar are provided in TABLE 2, according to one embodiment of the present invention:

TABLE 2

| Report Toolbar Button | Function |
|---|---|
| Reports | Start Report Retrieval Module |
| USER INFO | Enter User Contact Information |
| | Change Username/Password |
| | Control Report Distribution List |
| LOGOFF | Log Off User |

The ordering module is now discussed. The order setup screen is provided in FIG. 6. The Create New Order screen has two components. First, the selection dropdown lists on the left define the procedural center, type of services requested and the laboratory the service is requested from. Second, the controls on the right control patient selection. In each case, the drop down lists can be populated through data obtained from other databases, where the data is formatted to be presented in the manner preferred by the ordering system.

To create a new order, the Procedural Center (facility ordering services) is identified and then the Requested Services (i.e. Pathology, Radiology, etc.) is identified. Next, the Service Type is identified from the dropdown selection list and the Laboratory (facility providing the services) is selected. Then, Patients (by appointment date or name as described below) are searched for and a Patient is selected from the Search List by clicking “Select” next to the appropriate patient. In this example, the patient names are obtained when needed from the necessary database and “translated” by the data regulation layer. These steps are further discussed below.

The patient database can be searched by name, appointment date or unique identifier, where those data are obtained and converted from the database for the ordering system. The text and date boxes on the right control the patient search functions. Patients are usually selected by clicking the “Patients Scheduled For” button to create a list of patients scheduled on that day at the selected procedural center.

There are three ways to identify the patient for whom services are being ordered, according to this embodiment. First, a unique identifier can be used. If the user knows the patient's unique identifier in the database being searched, it may be entered in Unique ID textbox. If it is not known, the patient's unique ID, the Unique ID box is left empty. Alternatively, a patient search may be performed by name (last name, start of last name with wildcard, and first initial). If the patient's last name is known, it can be entered in the last name text box. If only part of the patient's last name is known, a wildcard search may be used. The wildcard search character is asterisk (*). The search may also be done by appointment date. If the name of the patient is not known or if a list of patients who had appointments on a particular day is desired, the appointment date can be entered in the Appointment Date Selection boxes.

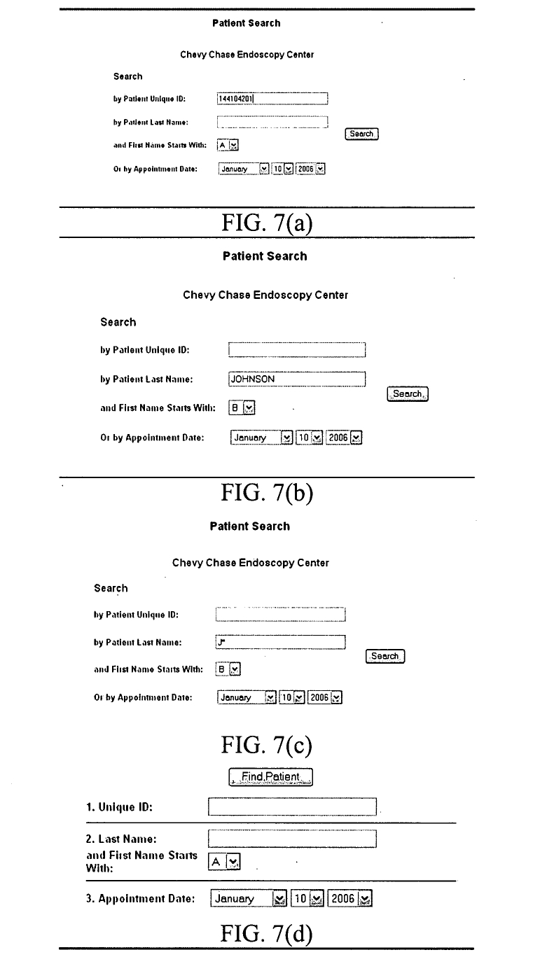

FIGS. 7(a) through 7(d) shows examples of each kind of search. FIG. 7(a) presents a unique ID search and FIG. 7(b) presents a name search, where the name being searched is “Johnson” where the first initial is “B.” A partial name search, using a wildcard, is illustrated in FIG. 5(c) and an appointment date search is presented in FIG. 7(d). It should be noted that if a unique ID or last name is specified, the appointment date is not used in the search.

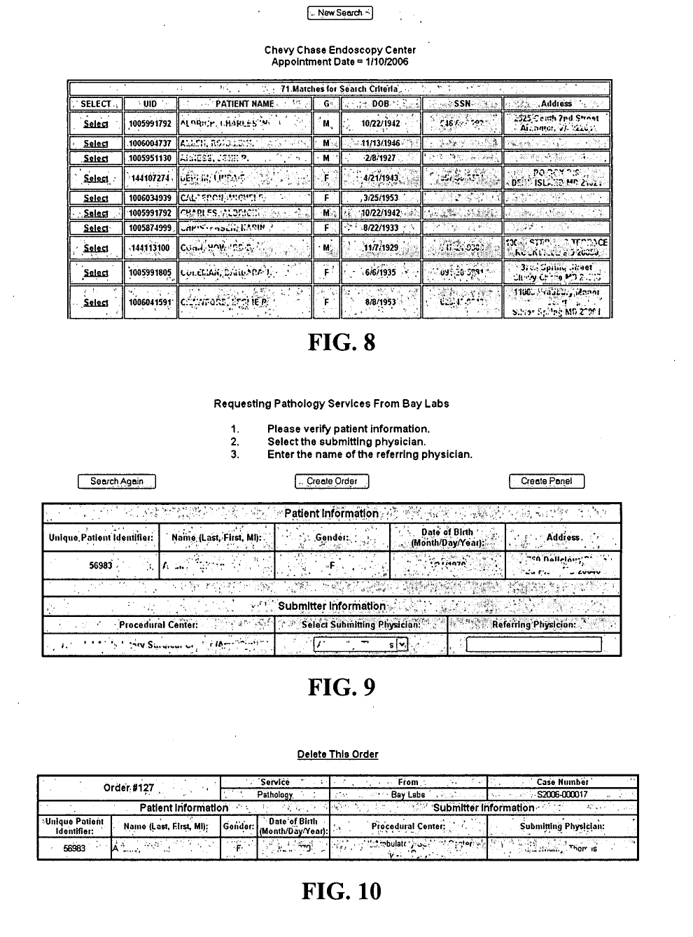

FIG. 8 presents a screen capture of the results of a search. The results table lists each patient's unique ID, name, gender, date of birth, Social Security Number and Address. The patient for whom services are required is selected by clicking the “Select” link in the row in which the patient is listed. If automated Patient Search and retrieval is not available, the patient search side of the ordering screen is replaced by a different series of controls.

Once the ordering facility, type of service, laboratory and patient information are verified on the Create Order Screen, the submitting and referring physicians may be entered at this time. This screen is presented in FIG. 9. If itemized specimens are to be ordered, the “Create Order” button is clicked. If the “Create Panel” button is selected to order a pre-defined list of specimens (i.e. a prostate panel). The Specimen Itemization Screen has three sections. Sections are illustrated in FIGS. 10-12.

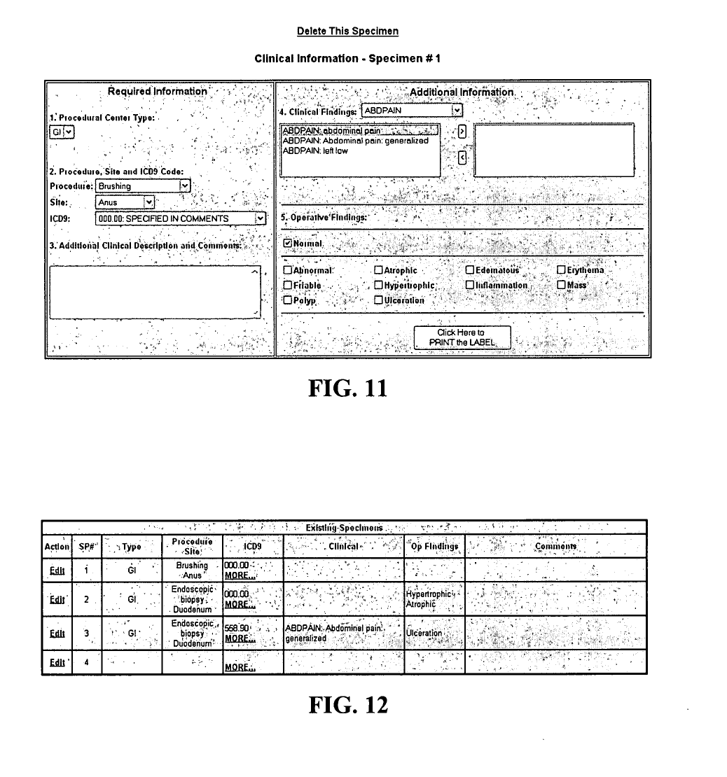

The Patient Information Section contains patient information, the ordering procedural center and the submitting physician for the order. This is illustrated in FIG. 10. The Specimen Clinical Information Section is used to enter a detailed description of each specimen that will be sent to the laboratory. This is illustrated in FIG. 11. The Specimen List Section shows the order's itemized specimens. This is illustrated in FIG. 12.

The process of how to attach a specimen to an order will now be discussed. The procedure, Site and ICD9 code are selected and the relevant clinical findings from the multi-select list are selected. The drop down lists general headings for clinical findings (for example, Crohn disease). An appropriate clinical finding is selected. Specific choices for the selected general heading appear in the multi=select list on the left. (For example “CROHN DISEASE: history of Crohn disease”, “CROHN disease: rule out Crohn disease”, “CROHN disease: specify”). The appropriate choice(s) for that patient are selected. Multiple findings can be added from different subcategories to the box on the right (for example, one could add “CROHN DISEASE: history of Crohn disease”, and “STRICTURE: small bowel”). If the wrong information is mistakenly added to the right side box, it can be removed through the left facing bracket (<). The operative findings are selected by checking the appropriate box(es) and any comments pertaining to this specimen can be entered. A label can thereafter be printed.

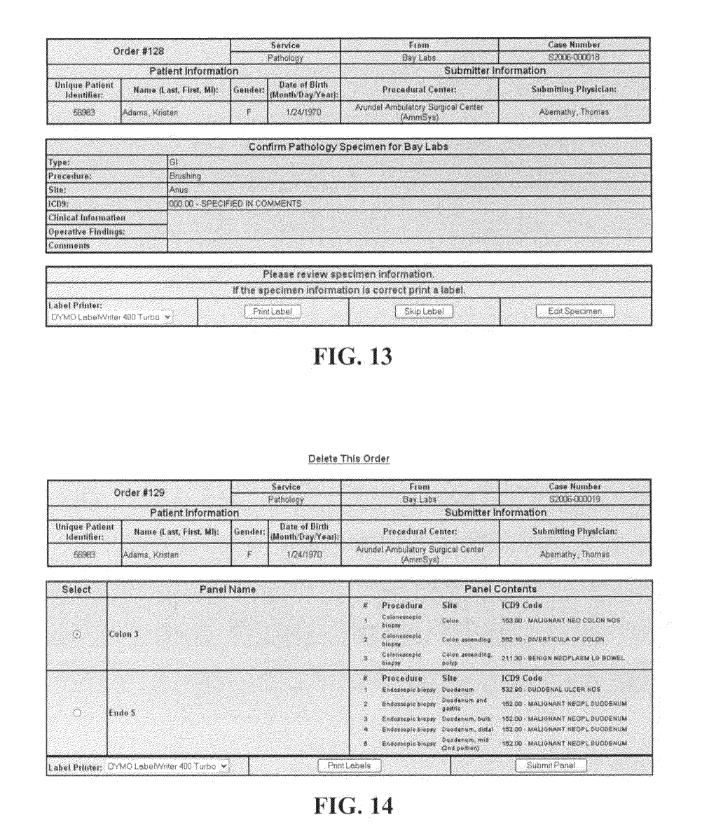

The print specimen label screen is presented in FIG. 13. The Print Specimen Label Screen summarizes patient and ordering information and details the information entered for the specimen to be labeled. To print the specimen label, a label printer is chosen from the network and “Print Label” is selected. The printed label is affixed on the specimen jar. If the specimen clinical information has not been entered correctly, “Edit Specimen” can be selected. Clicking “Edit Specimen” returns the user to the Specimen Itemization Screen so the specimen information may be edited or deleted. If a label printer is not available or if a label is already available for this specimen, then “Skip Label” can be selected.

Once “Print Label” or “Skip Label” is clicked, the specimen is added to the order. After the label is printed, existing specimens may be edited (or deleted) by clicking “EDIT Existing Specimens,” new specimens may be added to the order or the order may be submitted to the laboratory.

The Order Panel Screen is presented in FIG. 14. Panels are pre-defined lists of specimens. A panel is selected by clicking “Create Panel” on the Create Order Screen. The Order Panel Screen contains three sections. The Patient Information Section contains patient information, the ordering procedural center and the submitting physician for the order. The Panel Information Section lists each panel that is available to the procedural center. Select the desired panel by clicking the option button in the Select column. Each panel's content is summarized in the Panel Contents column. To print a label for each specimen in the selected panel, “Print Labels” can be selected. If the labels print correctly, the order may be submitted to the laboratory by clicking “Submit Panel”.

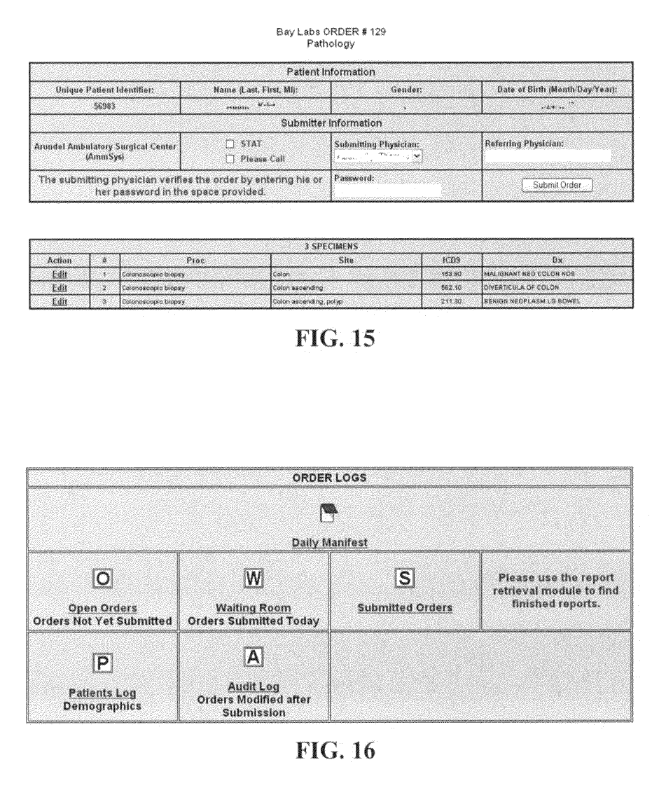

The Order Verification Screen is provided in FIG. 15. The following controls are available on the Order Verification screen. The STAT and Please Call Checkboxes may be selected to mark an order as STAT or Please Call when received by the service provider. The Submitting Physician Dropdown may be used to select submitting physician and the Referring Physician Textbox may be entered. A Password Textbox is available so that the submitting physician may verify the order by entering his or her password. The Submit Order Button submits the Order to the Waiting Room and the EDIT buttons returns the user to the Specimen Itemization Screen. In each case, the actual data which are used to populate the fields and used to exchange between systems is modulated using the data regulation discussed above.

After the order is submitted, a copy of the requisition to include in the order package, a copy for the chart records and a label for the specimen package may be printed. The links for Requisition Copy, Chart Copy and the button for Package Label may be selected to initiate each print out. The final screen of the Ordering module allows one to reprint any missing the requisition and chart receipts and the package label.

LOGS on the Ordering Module toolbar is selected to access the Order Logs Selection Screen. The screen is shown in FIG. 16. The following logs and reports are available.

Daily Manifest lists all waiting room and submitted orders for a procedural center by day. The printable list has columns for notes. Open Orders lists orders that have been created but have not yet submitted to the laboratory. These orders may be re-activated or deleted by clicking the appropriate link in the action column. Waiting Room contains orders that have been submitted but have not yet been received by the laboratory. The waiting room is the last chance to edit an order before submission. All changes made to any order in the waiting room are logged. The permission of a local Client Site Administrator (CSA) is required to edit or delete orders in the waiting room. Submitted Orders lists orders that have been received by the laboratory from a procedural center by date. Once received by the laboratory, an order cannot be modified. The status of an order is “S” (submitted) if the laboratory has received the order but has not produced a final report or “F” if the final report has been produced. Patients Log is an alphabetical listing patients and demographics from a procedural center. Only patients who have had orders created appear on this list. A complete set of patient demographics may be viewed and/or refreshed by clicking the link in the demographics column. The Audit Log is a list of all orders from a procedural center that have been modified after being submitted to the waiting room. Clicking “Show Audit” generates a report showing how, when and by whom the order was modified.

Patient demographics may be viewed and refreshed from the Open Orders, Waiting Room, Submitted Orders and Patients Logs. The link (complete or incomplete) in the demographics column may be selected to show a pop-up window containing the patient's recently extracted demographic (name, address, phone, gender, birthday, insurance, and guarantor) information. Missing demographic information will be noted in the pop-up window. Demographic information can be refreshed (re-extracted from the procedural center database) in the pop-up window by clicking the “Refresh Info” button.

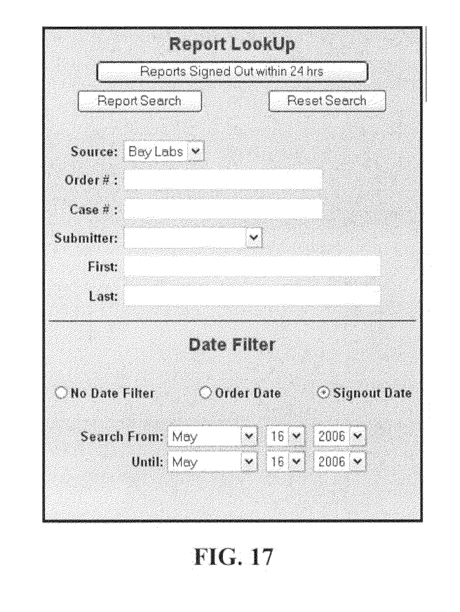

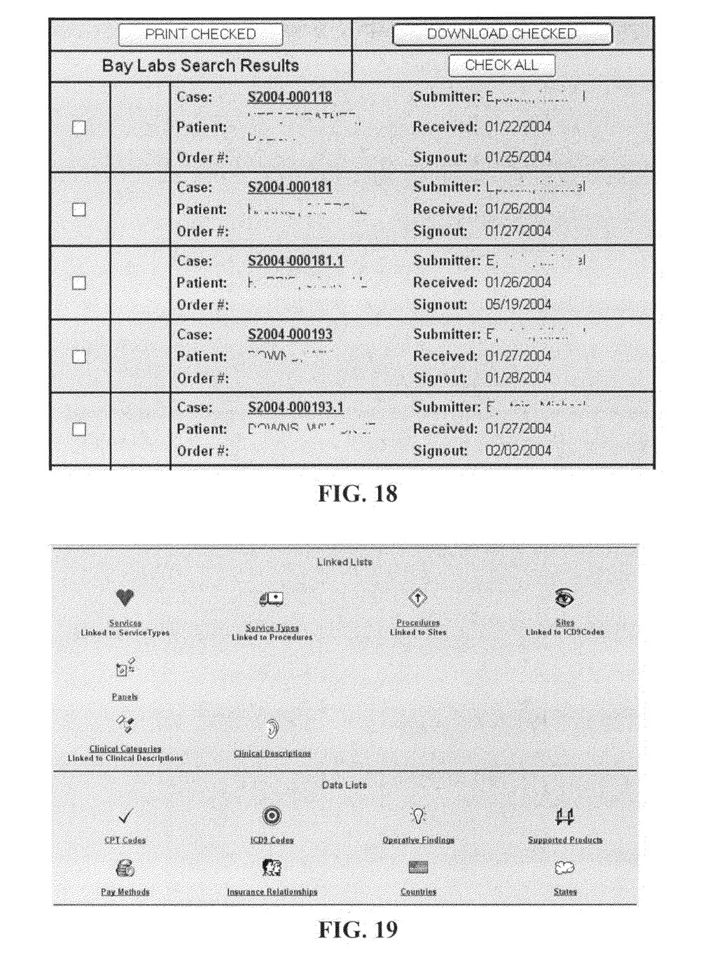

The report retrieval module has two sections. The Report Lookup Box, presented in FIG. 17, allows users to specify criteria for reports they'd like to find. The Report List Box, presented in FIG. 18, shows reports matching these criteria. The dropdown boxes allow users to specify the laboratory (facility creating the report), the Order number (from the Ordering Module), the Case Number (usually assigned by the reporting source), the Submitting Physician, or by the name of the patient. Again, the dropdown boxes are populated with data obtained and converted, as discussed above. Order Date or Sign Out Date may filter search results. The “No Date Filter” Option may be used to prevent data filtering. The “Reports Signed Out within 24 hrs” is selected to retrieve all reports signed out within the last 24 hours. The recent report search does not use the search criteria. The “Report Search” is selected to find reports matching the specified criteria. The “Reset Search” is selected to reset the search criteria controls.

The Report List Box, as presented in FIG. 18, shows the reports that match the search criteria. The case number, patient name, submitting physician, order number (if applicable), and received and sign out dates are displayed. If the case number link is selected to display the report in a preview window. The “Print Report” is selected in the pop-up window to print the report. As discussed above, the presentation of results is also mediated by the data regulating layer.

The User Information screen is available in both the Ordering and Reporting Modules. This screen allows site administrators to acquire up to date information for each user of the system. Valid user information is essential for optimal performance of the Electronic Ordering and Report Retrieval site. For example, an up to date and current email is required to send user information in the event that username and/or password information is lost. The following information may be entered and updated, as provided in TABLE 3.

TABLE 3

| Field | Required |
|---|---|
| Username | Y |
| Password | Y |
| Last Name | |
| First Name | |
| Middle Initial | |
| User Is a Doctor | |
| Company Name | |
| Address Line 1 | |
| Address Line 2 | |
| City | |
| State | |
| Zip | |
| Country | |
| Phone (Day) | |
| Phone (Other) | |
| Fax | |
| Email | |
| Web | |

Where either Last Name or a Company Name is required for a user and the email address is required if user wants to use the Username and Password retrieval utility on the log in screen. To update User Information, enter data into a field's corresponding text box and click the Update button on top of the table.

Turning to administrating access portion of the system, users with Administrative Access may click the Admin button from any module's toolbar to access the Administration Screens. Lists may be administered through this function.

Such lists are provided in FIG. 19. Linked Lists provides a linked list with drill-down selection to another list. Examples include selecting a Service (ie. Pathology) limits the available Service Type selections to GI, GS or Urology or selecting a particular procedure limits the available sites to those applicable to the chosen procedure. The linked lists available for the E-Ordering system are Services→Service Types where services offered by a laboratory (i.e. pathology) are provided and Service Types→Procedures where types of services offered by a procedural center (i.e. urology, GI) are provided. Additional linked list are Procedures→Sites where clinical process performed at the procedural center (ie brushing, colonoscopic biopsy) are provided, Sites→ICD9 Codes where location of the selected procedure (i.e. colon, prostate) are provided and Clinical Categories→Clinical Descriptions where type of clinical observation (i.e. abdominal pain, anemia) are provided.

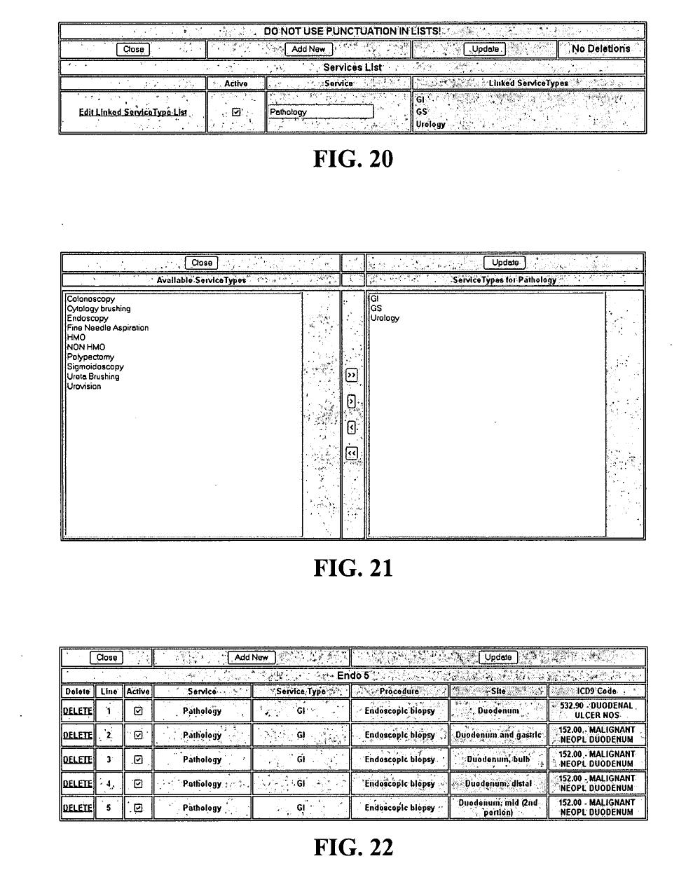

Also editable are Panels where a panel is a special type of linked list. Selecting a panel gives a predetermined specimen list (procedure, site and ICD9 Code). Data Lists are also editable where a data list is a simple list of entries. Selection into a data list terminates a linked list. Examples include: States in the USA, the International Classification of Diseases 9^{th} Edition (ICD9) Codes, current Procedural Terminology (CPT) Codes, clinical Descriptions where the specific nature of clinical observation (i.e. left lower abdominal pain, generalized abdominal pain) is provided, CPT Codes, the Clinical Procedure Code for billing purposes, ICD9 Codes, Operative Findings such as observations (ie. Abnormal, mass), Supported Products such as commercial products supported by E-Ordering/Reporting modules (ie. Medicrus, EmedSys), Pay Methods where the payment methods for a user (Visa, No Pay) include, Insurance Relationships where the relationship of patient to policy holder (i.e. self, spouse) is provided, countries of the world and provinces of Canada. Items can be added to lists, deleted from lists and lists can be edited. Items can also be linked to lists through this feature as illustrated in FIG. 20, where the Service Type Administration screen, FIG. 21, is selected through the “Edit Linked Service Type List.”

In the Ordering Module a procedure, site and ICD9 Code define a specimen. Other information, such as clinical descriptions and operative findings may optionally be used to describe a specimen. Usually, the Specimen Itemization Screen is used to describe each specimen included in an order. Many procedural centers routinely prepare standard sequences of specimens for the laboratory. These standard sequences are called panels. Ordering a panel is a quick way of defining a large group of specimens that comprise an order. A panel definition consists of the contents of a panel (the specimen sequence), the source (the procedural center placing the order) and the panel destination (the laboratory). Panels can be added and/or edited, where the Panel Item Management Screen is presented in FIG. 22. The Panel Line Item Management Screen details the specimen sequence of the panel. A New Line Item can be added. To define a line item, a service, service type, procedure, site and ICD9 code should be select. List Items may removed by clicking the “Delete” hyperlink in the first column. The Active/Inactive check box is also used to control panel content.

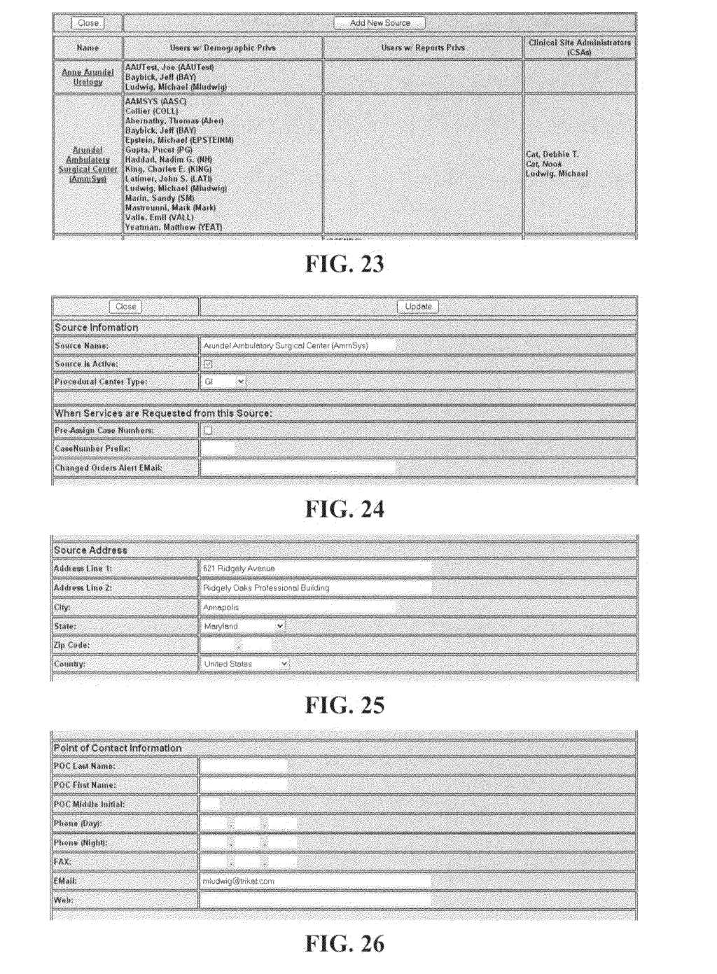

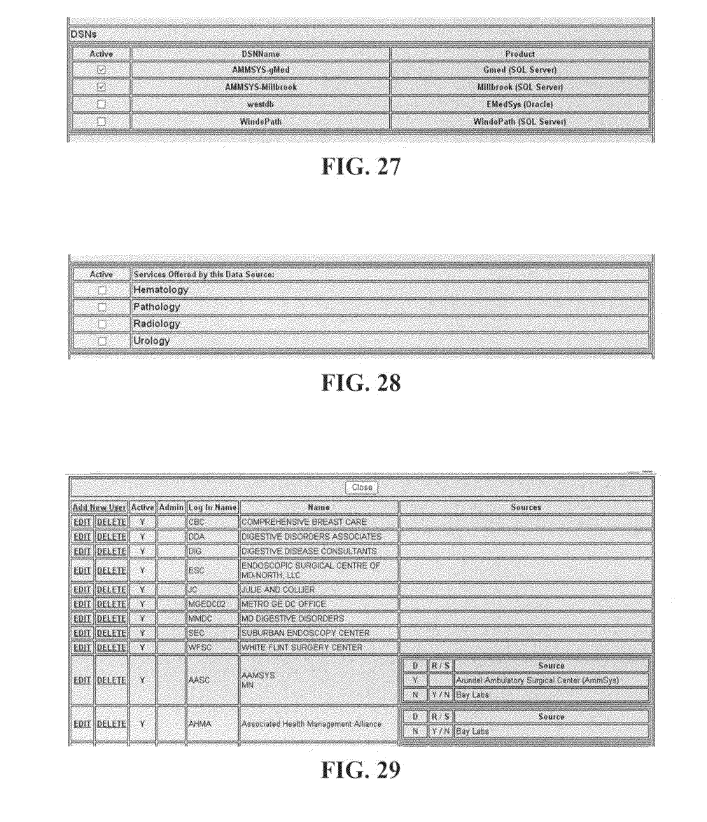

The Data Source Administration Screen, as presented in FIG. 23, lists each data source, users who are allowed to retrieve patient demographics from the source, users who are allowed to retrieve reports from the source and the Client Site Administrators (CSAs) for the data source. The Data Source Configuration Screen is used to control the data source. Procedural Centers and Laboratories are types of data source. Source Information includes Source Name, Source Is Active and Procedural Center Type. When Services are Requested from this Source, these contain Pre-Assign Case Numbers, Case Number Prefix and Changed orders alert Email. An example data source configuration is provided in FIG. 24. To edit Clinical System Administrators, the add/update CSA list is selected. The CSA screens are completely analogous to the User Screens described below and are illustrated in FIG. 24. The Source Address and Point of Contact Information allows for entry of address, point of info name and contact information, in FIGS. 25 and 26. The Data Source Names (DSNs) is used to select which ODBC connections are used by the data source, as provided in FIG. 27. The Services Offered By this Source allows for the selection of the services this source provides, as presented in FIG. 28.

The users administration screen is presented in FIG. 29. The status (active or inactive), administrative privileges, login name, and available data sources for each User are listed on the User List Screen. In the Sources column the data sources available to the user and the type of access a user has is listed. If a source is not listed for a user, the user has no access to the source. Users and access can be edited.

The Submitter Configuration Screen is used to allow users to participate in the E-Ordering process. Orders, sent from procedural centers to laboratories, belong to the user under whose name they are submitted in the Order Verification Screen. Cross-referencing a user of the E-Ordering/Reporting system with the software used by the laboratory to create the final report allows maintains confidentiality at the reporting level. The top portion of the Submitter Configuration Screen is used to cross reference a user of the E-Ordering system with the laboratory software that creates the final reports (ie WindoPath). The drop down list contains users who are allowed to submit orders to the laboratory's reporting system. Select the laboratory user that corresponds to the user of the E-Ordering/Reporting system. The lower portion of the Submitter Configuration Screen is a multi-select list. This section is used to set the distribution list for reports concerning orders submitted by the user.

In addition, a transaction log may be produced that lists system usage (submitted orders and viewed reports) by user and month. The Scheduler Log lists start and run times of the E-Reports utility programs. The Utility Program can be configured to automate the final submission of orders in the Waiting Room to the destination laboratory. Task W denotes that the Waiting Room has been cleared and that all orders have been successfully submitted to the processing laboratory. The Utility Program can also be used to re-extract patient demographics from a procedural center source in order to maintain up to date demographic records in E-Reporting system.

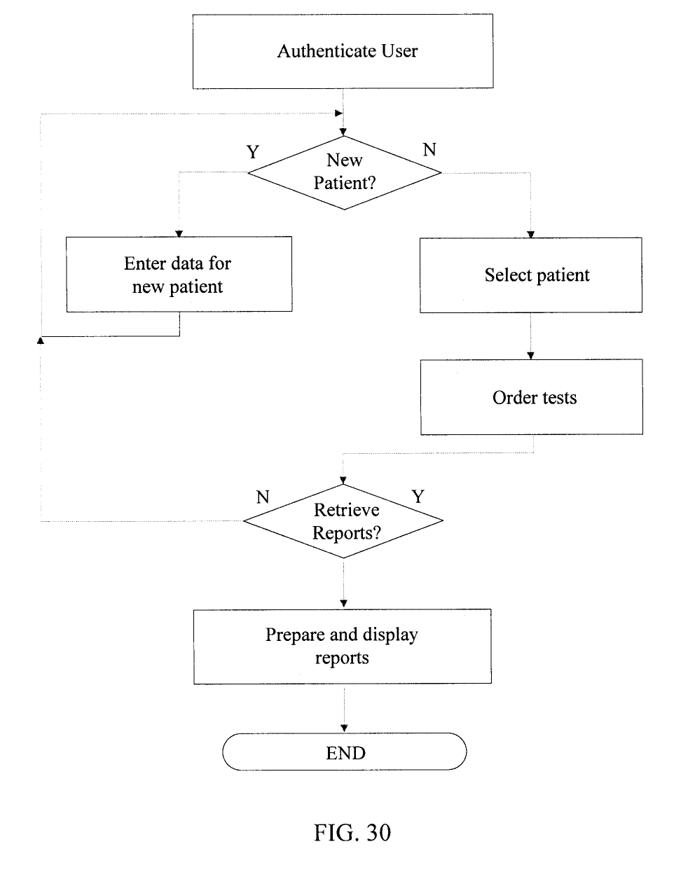

A general flow chart for the use of the system of this embodiment of the present invention is presented in FIG. 30. The user is authenticated and queried as to what type of service they are seeking. If testing services are selected, then the user either selects a patient, based on search criteria discusses above, or enters data pertinent to a new patient. After selection of the patient, tests or panels of tests are ordered, with the printing of labels being an option. The user is queried about reports and if no reports are requested, then the system enables the request for more testing. If reports are requested, then reports are prepared and requested, as discussed above.

The present invention provides a system that allows for the rapid storage and retrieval of medical information. The system allows a transparent exchange of medical record information and also allows for existing (embedded but intrinsically incompatible) systems to interoperate by inserting a layer of data regulating software. Without requiring changes or updates to the existing systems, the methodology of the present invention allows for the exchange of medical data between practices, hospitals and laboratories. Practitioners can continue to use their existing systems and no external data conversion processes are required.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

We claim:

1. A medical records system, comprising:
an interface module having a user interface to allow a user to request and retrieve data regarding patient records;
data regulating software; and
a database of medical records and patient data;
wherein the interface module is configured to allow for selection of patient identifiers, selection of data requests with respect to the patient identifiers and the medical records and retrieval of information related to the patient identifiers and the medical records, where the patient identifiers, data requests and retrieval of information are communicated between the interface module and the database through regulation by the data regulating software.

2. A medical records system according to claim 1, wherein the interface module is a personal computer connected to a network and the database is a networked database.

3. A medical records system according to claim 2, wherein the interface module is a tablet personal computer wirelessly connected to the network.

4. A medical records system according to claim 1, wherein the interface module is a personal computer and the user interface is a browser window being served from a network source connected with the database and the data regulating software.

5. A medical records system according to claim 1, wherein the user interface is configured to allow for the entry of new patient data and the data regulating software is configured to convey the new patient data to the database in a format used by the database.

6. A medical records system according to claim 1, wherein the user interface is configured to allow for selection of patient identifiers through the search for an ID, at least a partial name and an appointment date.

7. A medical records system according to claim 1, wherein the data regulating software is configured to translate the data obtained from the database such that the data are formatted to meet the requirements of the interface module.

8. A medical records system according to claim 1, wherein the database and the data regulating software are accessed over a network by the interface module, with the data regulating software configured to mediate communication between the database and the interface module.

9. A medical records system according to claim 1, wherein the database of medical records and patient data comprises multiple databases of medical records and patient data and wherein the data regulating software provides data translation into separate formats for each of the multiple databases.

10. A medical records system according to claim 1, wherein the data regulating software is compatible with multiple commercial practice management software packages.

11. A method of accessing medical data, comprising the steps of:
providing a user with an user interface;
awaiting the user to request data regarding patient records, including selection of patient identifiers, selection of data requests with respect to the patient identifiers and the medical records and retrieval of information related to the patient identifiers and the medical records;
communicating the patient identifiers, data requests and retrieval of information to data regulating software;
translating the patient identifiers, data requests and retrieval of information by the data regulating software; and
forwarding the translated patient identifiers, data requests and retrieval of information to a database of medical records and patient data;
wherein the translating step translates patient identifiers, data requests and retrieval of information into a format used by the database.

12. A method according to claim 11, wherein the method is performed on a personal computer connected to a network and a networked database and data regulation software.

13. A method according to claim 11, wherein the step of providing the user interface comprises providing a selection of patient identifiers is made through a search of at least one of an ID, at least a partial name and an appointment date.

14. A method according to claim 11, further comprising translating the data obtained from the database such that the data are formatted to meet the requirements of the interface module.

15. A method according to claim 11, wherein the database and the data regulating software are accessed over a network by the interface module, with the forwarding step comprises mediating communication between the database and the interface module.

16. A method according to claim 11, wherein the database of medical records and patient data comprises multiple databases of medical records and patient data and wherein the translating step comprises translating data into separate formats for each of the multiple databases.

17. A method according to claim 11, wherein the translating step comprises preparing data compatible with multiple commercial practice management software packages.

18. A computer program product, having a computer program embodied in a computer readable medium, adapted to perform a method of accessing medical data, comprising the steps of:
providing a user with an user interface;
awaiting the user to request data regarding patient records, including selection of patient identifiers, selection of data requests with respect to the patient identifiers and the medical records and retrieval of information related to the patient identifiers and the medical records;
communicating the patient identifiers, data requests and retrieval of information to data regulating software;
translating the patient identifiers, data requests and retrieval of information by the data regulating software; and
forwarding the translated patient identifiers, data requests and retrieval of information to a database of medical records and patient data;
wherein the translating step translates patient identifiers, data requests and retrieval of information into a format used by the database.

19. A computer program product according to claim 18, wherein the method is performed on a personal computer connected to a network and a networked database and data regulation software.

20. A computer program product according to claim 18, wherein the step of providing the user interface comprises providing a selection of patient identifiers is made through a search of at least one of an ID, at least a partial name and an appointment date.

21. A computer program product according to claim 18, further comprising translating the data obtained from the database such that the data are formatted to meet the requirements of the interface module.

22. A computer program product according to claim 18, wherein the database and the data regulating software are accessed over a network by the interface module, with the forwarding step comprises mediating communication between the database and the interface module.

23. A computer program product according to claim 18, wherein the database of medical records and patient data comprises multiple databases of medical records and patient data and wherein the translating step comprises translating data into separate formats for each of the multiple databases.

24. A computer program product according to claim 18, wherein the translating step comprises preparing data compatible with multiple commercial practice management software packages.
